(19) United States
(12) Patent Application Publication
(10) Pub. No.: US 2012/0156494 A1
(43) Pub. Date: Jun. 21, 2012

(54) METHOD FOR PRODUCING DISPERSIONS HAVING METAL OXIDE NANOPARTICLES AND DISPERSIONS PRODUCED THEREBY

(76) Inventors: Christian Wolfrum, Erlangen (DE); Stefan Trummer, Nurnberg (DE); Marco Greb, Gelnhausen (DE); Michael Grüner, Auerbach (DE); Dieter Prölss, Schwabach (DE)

(21) Appl. No.: 13/390,621

(22) PCT Filed: Aug. 10, 2010
(86) PCT No.: PCT/EP10/04874

§ 371 Date: Mar. 9, 2012

(30) Foreign Application Priority Data
Aug. 20, 2009 (DE) 10 2009 037 992.4

(51) Int. Cl. B32B 5/16; B02C 23/00; B82Y 40/00

(52) U.S. Cl. 428/402; 241/25; 977/892

(57) ABSTRACT

A process for producing a dispersion containing metal oxide nanoparticles in a liquid phase, wherein the process comprises the following steps: (a) atomization of a metal melt to give a metallic powder, (b) optionally deformation of the metallic powder obtained in step (a), (c) oxidation of the metallic powder obtained in step (a) or (b) to give a metal oxide powder, (d) comminution of the metal oxide powder obtained in step (c) in the presence of a liquid phase to give a dispersion whose metal oxide particles have a particle size d_{90,oxide} of less than 300 nm. The invention further relates to a dispersion which can be obtained by the process of the invention.

The present invention relates to a process for producing a dispersion containing metal oxide nanoparticles in a liquid phase.

Dispersions are mixtures of at least two materials which are not soluble in one another and in which one material, the disperse phase, is finely distributed in the other material, the dispersion medium. Both disperse phase and dispersion medium can be solid, liquid or gaseous. In the case of mixtures of solids and liquids, the dispersions are also referred to as suspensions. When the solid is present as particles having a diameter in a size range from 1 nm to 10 000 nm (10 μm), such suspensions are also referred to as colloids. The term colloids is used particularly when the particle diameter of the solid particles is less than 200 nm, i.e. when the solid particles are present as nanoparticles.

The stability of these dispersions is influenced greatly by the surface chemistry and surface physics. A stable dispersion is for these purposes a dispersion which retains a particle diameter in the abovementioned range for a prolonged period of time, in particular days, weeks or months. In unstable dispersions, aggregation of solid particles occurs, so that particle aggregates having a larger diameter are formed. The aggregation can be caused by a variety of effects. Possible causes are interactions between the particles, e.g. van der Waals forces, dipole-dipole interactions, hydrogen bond formation and hydrophobic interactions. Owing to the high specific surface area of the colloidal solid particles, the tendency for aggregation to occur is very high. Furthermore, colloidal particles are often moved in the liquid by Brownian molecular motion, as a result of which the probability of a collision and subsequent aggregation is very high even in dispersions which are not subjected to mechanical stress. Modification of the solid particles or of the liquid is therefore in most cases necessary to stabilize the dispersions.

Various methods are employed for stabilization.

In one variant, the dispersion of the solid particles is stabilized electrostatically. An electric charge can be produced on the surface or on the immediate vicinity thereof by targeted modification of the particle surface, for example by attachment of molecules, by setting of a particular pH of the dispersion or by loading of the particle surface with ions or electrons. This charge can, for example, be expressed and also measured by the zeta potential of the particles. The particles bearing like charges then repel one another, so that aggregation is avoided.

In a second variant in which the dispersion is sterically stabilized, bulky molecules, for example polymers, long-chain alkanes, surfactants, etc., are arranged or covalently bound on/to the surface of the particles. These bulky molecules prevent the particles from coming into close proximity and thus prevent aggregation.

In a third variant, the dispersion is stabilized by means of electrosteric stabilization. Here, use is made of molecules which firstly effect steric shielding and secondly also bring about electrostatic shielding by means of charge carriers. Polyelectrolytes are usually used for this purpose.

Various methods of producing colloids are known.

Most of the processes described are ones in which nanoparticles are firstly produced and these are subsequently dispersed in a liquid. The nanoparticles can be produced by a large number of methods.

US 2003/0231992 discloses a process for producing nanoparticles by means of a plasma-aided gas-phase synthesis in which a metal is vaporized by means of an electric arc and reacted with a reactive gas.

WO 2006/071199 A1 discloses a process for producing nanoparticles, in which zinc is converted into the vapor phase and the zinc vapor is oxidized to nanoparticulate zinc oxide by reaction with an oxidizing gas with introduction of heat.

Processes for producing aluminum oxide nanoparticles by hydrolysis of AlCl₃ by high-temperature or flame hydrolysis are known from Ullmann's Encyclopedia of Industrial Chemistry, fourth edition, volume 21, page 464 (1982).

WO 03/080515 A1 likewise discloses a process for producing nanoparticulate zinc oxide. In this process, zinc powder is firstly vaporized without oxidation and the zinc vapor formed is subsequently oxidized to zinc oxide by introduction of air or oxygen. The product obtained is a powder made up of aggregated nanoparticles.

Disadvantages of the abovementioned process and further gas-phase syntheses of nanoparticles are that these processes have a high energy consumption, partly require expensive starting materials and partly have only a low production rate. A further great disadvantage is that the nanoparticles aggregate during separation from the gas stream. Here, either weak aggregates and also to a significant extent very stable aggregates, e.g. due to sintering bridges between the particles, can be formed. However, in this aggregated form, the positive use properties of these particles can be utilized to only a limited extent. The particles are therefore generally dispersed by introducing the agglomerates or aggregates of the solid particles into a liquid and at the same time or subsequently comminuting the aggregates before the actual use. The primary particle sizes of the solid particles introduced are not changed in this operation. In the dispersing operation, the particles are thus merely separated and no comminution takes place. In the dispersing operation, the particle size distribution measured, for example, by a laser light scattering method changes but the size of the primary particles as such, which can be determined, for example, by means of electron-microscopic methods, remains unchanged. In the dispersing operation, one or more of the methods mentioned above is/are used for stabilizing the dispersion in order to protect the particles against reaggregation during and after the dispersing operation. For example, DE 102006025848 A1 describes a process for dispersing agglomerates, in which pulverulent aggregates are firstly comminuted with input of energy in a gas phase and are subsequently dispersed in organic-based matrix particles.

US 2004/0258608 A1 describes the dispersion of aggregates of nanosize individual particles which have been produced by a gas-phase synthesis, in water, with input of energy and with addition of cyclic phosphates and/or copolymers.

US 2003/0032679 A1 discloses the dispersion of aggregates of nanosize individual particles which have been produced by means of a gas-phase synthesis in nonaqueous liquids, with input of energy and with addition of polymeric dispersants.

DE 102004048230 A1 discloses a process for dispersing nanosize particles with thermal treatment of the particles and subsequent dispersion by means of energy input in the presence of a dispersant and a modifier which modifies the particle surface.

WO 2008/035996 A2 discloses the production of nanoparticles by decomposition of an electrically conductive material by introduction of electric current. Such a process is unsuitable for the industrial production of dispersions, especially because of the low production rate.

In the processes used in the prior art, dispersions are produced by firstly producing nanoparticles via various initial stages and subsequently dispersing these in a liquid or by synthesizing the nanoparticles directly in a liquid. Since the nanoparticles are produced by synthesis from smaller starting materials, for example vapor, salts, etc., in each of these processes, these processes are also referred to as “bottom-up” processes.

Processes in which nanoparticles are produced by comminution of larger solids are therefore referred to as “top-down” processes. The comminution of the larger solids is usually carried out in mills, very often in stirred ball mills.

For example, DE 10304849 A1 discloses a process for producing a colloid, in which particles are produced by comminution in the presence of a modifier which reacts chemically with the surface of the particle.

In these processes, mills are usually used for comminution. Stirred ball mills are preferably used. In these mills, loose milling media, usually milling balls composed of a hard metal oxide, are used for comminution. Owing to the underlying comminution mechanism and the mill construction, the size ratio between the milling balls and the material to be comminuted cannot be increased at will. To produce dispersions having primary particle sizes of less than 100 nm, preference is given to using balls having a diameter of less than 1 millimeter or significantly smaller, i.e. down to 0.05 millimeter. As a result, the maximum average size of the material to be comminuted is greatly restricted since the small milling media would otherwise no longer lead to comminution. The diameter of the starting material must usually be no greater than 0.5 millimeter. The diameter is typically less than 0.1 millimeter.

The production of such a fine starting material is troublesome. Use is often made of aggregated nanomaterials which have been produced by one of the bottom-up processes described and have the disadvantages described. Materials which have been pre-comminuted in a first comminution step are also used. However, this first step is costly and energy-consuming. Materials which occur in natural form in a suitable size are sometimes also used. However, these are highly contaminated so that either the end product likewise contains these impurities or else these have to be removed before the final comminution, which is expensive.

There are accordingly many processes by means of which dispersions can be produced. However, these have the disadvantages described.

It is an object of the invention to provide a simple process by means of which dispersions of nanoparticles can be produced industrially. This process should, in particular, not have the disadvantages described for the prior art.

The object of the invention is achieved by provision of a process for producing a dispersion containing metal oxide nanoparticles in a liquid phase, wherein the process comprises the following steps:
(a) atomization of a metal melt to give a metallic powder,
(b) optionally deformation of the metallic powder obtained in step (a),
(c) oxidation of the metallic powder obtained in step (a) or (b) to give a metal oxide powder,
(d) comminution of the metal oxide powder obtained in step (c) in the presence of a liquid phase to give a dispersion whose metal oxide particles have a particle size d_{90,oxide} of less than 300 nm.

Preferred embodiments of the process of the invention are indicated in the dependent claims.

The dispersion which can be obtained by the process of the invention can also be referred to as a colloid. The shape of the metal oxide particles or of the metal oxide powder is inconsequential in this case. It is possible for more or less spherical, rectangular, square, rod-like, platelet-like or unshaped metal oxide particles to be present. As a result of the small diameter of the metal oxide particles, these have a very large surface area in relation to their volume. For this reason, the dispersion which can be obtained by the process of the invention has very large interfacial areas between the metal oxide particles and the liquid and the macroscopic behavior of the dispersion is therefore determined to a great extent by effects of surface chemistry or surface physics.

The inventors have surprisingly found that dispersions comprising metal oxide nanoparticles can be produced in a simple way by the process of the invention. In particular, it has surprisingly been found that essentially no, preferably no, metal oxide aggregates, especially no metal oxide aggregates bridged by sintering bridges, are formed in the oxidation step (c) of the process of the invention, unlike the prior art.

Furthermore, the process of the invention allows a surprisingly high production rate. The process of the invention is therefore particularly suitable for the large-scale industrial production of dispersions comprising metal oxide nanoparticles.

As metallic starting material, it is possible to use all metals and alloys thereof.

In a preferred embodiment of the invention, the metals aluminum, iron, copper, magnesium, zinc, tin, zirconium, hafnium, titanium or alloys or mixtures thereof have been found to be suitable. The alloys preferably have 2, 3, 4 or more metals.

The metals aluminum, zinc, tin, titanium, iron, copper or alloys or mixtures thereof are preferably used as starting material. In a variant of the process of the invention, aluminum, zinc, iron or alloys or mixtures thereof are particularly preferred.

The purity of the metals is preferably greater than 70% by weight, more preferably greater than 90% by weight, particularly preferably greater than 95% by weight, in each case based on the total weight of the metal, of the alloy or the mixture.

In the process of the invention, the metal, the metal mixture or metal alloy is firstly melted by application of heat.

The melt of the metal, the metal mixture or metal alloy can be produced by the methods of melting metal(s) which are known to those skilled in the art. In particular, the metal melt can be produced by melting a metal in a melting furnace or crucible with introduction of heat. The heat can be generated using a burner or inductive heating or resistance heating.

In process step (a) of the process of the invention, a metallic powder or metal powder is produced by atomization of the metal melt.

The metallic powder can be produced from the liquid molten metal by, for example, suddenly injecting and thus atomizing the molten metal by high-pressure gas expansion into a space. Atomization of the molten metal can also be carried out by applying the molten metal to a rotating plate or disk, after which the applied molten metal is flung off as droplets having diameters in the nanometer to micron range (rotary disk method). Instead of a rotating plate or disk, the molten metal can also be applied to rotating rolls or rollers and flung off from these as droplets. The liquid metal which has been flung off as droplets in the nanometer to micron range cools during flight and solidifies.

The metallic powder or metal powder is particularly advantageously produced by gas atomization. Units, for example Laval units, are used for this purpose.

In these Laval units, the molten metal is greatly accelerated and subsequently brought to a high speed by further acceleration. At the outlet opening, the molten metal is suddenly expanded at high speed into a space and atomized in the process. In the sudden atomization, the material is preferably divided and/or broken up further by means of inflowing gas. Finely divided and/or broken up metal droplets are obtained and these solidify on cooling and then form a metallic powder.

The process variants of external mixing and internal mixing which are known to those skilled in the art are suitable for production of the metallic powder.

Particular preference is given to processes which allow precise control of the powder properties, in particular the powder size distribution. The particle size distribution of the metallic powder formed can, for example, be determined by means of laser light scattering methods. The particle size of the metallic powder formed can be controlled via the temperature of the metal melt, the energy introduced for atomization of the metal melt, the amount of gas, the gas pressure and/or the gas flow of gas introduced into the atomized metal melt.

As gas, use is made of gases suitable for atomization of the particular metal. The gas is selected in such a way that, for example, the process parameters are optimized by the type of gas, the particle size distribution is optimized and/or chemical reactions of the metal with the gas are reduced or increased. The gas can be, for example, an inert gas, a noble gas or a reactive gas. For example, the gas can be selected from the group consisting of nitrogen, argon, helium, oxygen, air, carbon dioxide and mixtures thereof.

In a variant of the process of the invention, the metal powder obtained after atomization can be classified on the basis of particle size. Size classification can be carried out, for example, by means of a cyclone, sieving, etc.

In a further preferred embodiment, the atomization of the molten metal is carried out so that particle size classification is no longer necessary.

The metallic powder or metal powder produced particularly preferably has a particle size distribution having an average size (D₅₀) in the range from 5 to 100 μm, preferably from 10 to 80 μm, more preferably from 15 to 50 μm, even more preferably from 20 to 40 μm.

In a further preferred variant, the metallic powder or metal powder produced has a particle size distribution in which the particles obtained approximately have a particle size having a D₉₉ of not more than 100 μm, more preferably not more than 80 μm, even more preferably not more than 50 μm, even more preferably not more than 40 μm. A D₉₉ of not more than 30 μm has been found to be very suitable.

A D₅₀ means that 50% of all particles have a particle size which is equal to or less than the value indicated. Correspondingly, a D₉₉ means that 99% of all particles have a particle size which is equal to or less than the value indicated.

The particle shape of the metallic powder produced is preferably approximately spherical. However, the powder can also have particles which are irregularly shaped and/or are present in the form of needles, rods, cylinders or platelets.

The metallic powder obtained can optionally be deformed in step (b), for example by introduction of mechanical energy, in the process of the invention.

The deformation preferably produces particles having a high aspect ratio. The aspect ratio is for the present purposes defined as the ratio of diameter to thickness of the particles. After deformation, the particles advantageously have an aspect ratio in the range from 3:1 to 2000:1, preferably from 5 to 1000, even more preferably from 10 to 500.

The particles after deformation particularly preferably have a size of less than 25 μm, more preferably less than 20 μm, even more preferably less than 10 μm, in at least one dimension. The mechanical deformation is advantageously carried out by milling of the metallic powder in mills. As mills, it is possible to use attritors, ball mills, stirred ball mills, etc. The metallic powder can be milled in this case, together with milling aids and preferably a liquid, for a suitable time of, for example, from more than 10 minutes to 100 hours, preferably from 30 minutes to 50 hours, even more preferably from 1 hour to 25 hours, in a ball mill containing milling media, preferably milling balls. The milling time is selected according to the desired degree of deformation and/or as a function of the ductility of the metal to be deformed. Such deforming is described, for example, in DE 102007062942 A1, whose contents are hereby incorporated by reference.

Processes for producing metallic powder having an average particle size D₅₀ in the range from 1 μm to 100 μm are known to those skilled in the art and are used industrially. The processes for producing metallic powders or metal powders are therefore industrially mature and have been optimized in respect of economics and energy consumption.

Compared to other processes for producing colloids indicated at the outset in the discussion of the prior art, in which the metal has to be additionally vaporized after the melting process, the metallic powders in the micron range can be produced using a significantly lower energy input since the energy of vaporization does not have to be introduced.

This can be very clearly shown for the example of aluminum. The melting point of aluminum is about 660° C., while the boiling point of aluminum is about 2460° C.

The heat of fusion is 10.79 kJ/mol, while the heat of vaporization is 293.4 kJ/mol. A large amount of energy is therefore saved when the metal has to be converted only into the liquid state but not into the gaseous state. However, atomization of molten metal does not make it possible to produce metal oxide particles whose particle diameter is completely or predominantly in the nanometer range, in particular whose D_{99,oxide} is less than 300 nm.

After atomization and optional deformation, the metal of which the metallic particles are composed is largely present in the oxidation state zero.

Usually, at least 50% by weight, for example at least 60% by weight or at least 70% by weight, of the metal of the metallic particles, based on the total weight of the metallic particles, is present in the oxidation state zero. Owing to natural oxidation, it is possible for a thin oxide layer to be formed on the periphery of the particles.

In step (c) of the process of the invention, the metallic particles are first oxidized. This oxidation can be carried out by all processes known to those skilled in the art.

In a preferred process variant, the metallic particles are oxidized by means of gas-phase oxidation and/or liquid-phase oxidation.

The oxidation is preferably carried out in a liquid or by combustion in a gas stream.

When the oxidation is carried out in a liquid phase or liquid, this is preferably effected by firstly dispersing the powder in the liquid phase or liquid. This can be brought about with or without addition of auxiliaries and with or without input of energy. The dispersing operation is preferably carried out without addition of auxiliaries and with stirring.

The liquid can be an inert liquid which does not have an oxidizing action or be a reactive liquid which has an oxidizing action and reacts with the metallic particles. Accordingly, the oxidation either commences immediately after dispersion or is started by addition of an oxidant and/or oxidation catalyst and/or by increasing the temperature.

If the liquid is reactive and reacts with the metal, the oxidation can also commence during the dispersing operation. Whether the oxidation reaction commences immediately depends in each case on the combination of liquid/metallic powder selected. The oxidation is preferably started by addition of an oxidant and/or oxidation catalyst. The reaction mixture is preferably heated during oxidation to accelerate the oxidation reaction.

Examples of oxidants are sulfuric acid, potassium permanganate, hydrogen peroxide and further oxidants known to those skilled in the art. Examples of oxidation catalysts are metals, metal salts, acids and bases. Particularly when acids and bases are added, the addition is preferably carried out so that a pH suitable for the oxidation reaction is set in the reaction mixture. After the reaction has started, it is preferably maintained until at least 90% by weight, more preferably at least 95% by weight, even more preferably at least 99% by weight, of the metal, in each case based on the total weight of the metallic particles, is present in an oxidation state other than zero. In a preferred embodiment, particles are present completely as metal oxide after the oxidative treatment.

The proportion of metal oxide can be experimentally determined by methods known to those skilled in the art. During the oxidation reaction, the temperature can be increased, reduced or kept constant. In addition, a further addition of one or more oxidants and/or oxidation catalysts can be carried out, by which means the oxidation process can be controlled. During the oxidation, it is possible, optionally with addition of further reaction components, for additional chemical reactions to be triggered and/or further components, for example metals or metal oxides, to be incorporated into the metal oxide particles being formed, for example as dopant.

The chemical and physical properties of the metal oxide particles, their size and their morphology can be set in a targeted way via the choice of these reaction parameters. The reaction parameters are preferably set so that the oxidation product has properties which aid the final comminution and/or are advantageous for a desired use. The parameters are particularly preferably selected so that the D₉₉ of the metal oxide particle size is less than 200 μm, preferably less than 100 μm, more preferably less than 80 μm, even more preferably less than 50 μm, even more preferably less than 40 mm or less than 30 μm. In a further preferred variant, the metal oxide particles obtained have a porous or layer structure. A porous or layer structure of the metal oxide particles obtained can be advantageous in the further comminution to a particle size having a particle diameter of less than 300 nm, since in this case low mechanical forces are required.

Preferred chemical reactions which lead to oxidation of the metallic powder are:

2Al+4H₂O→2AlOOH+3H₂

2Fe+2H₂O→2Fe(OH)+H₂

Zn+H₂O→ZnO+H₂

2Cu+H₂O→Cu₂O+H₂

These oxidation reactions are presented as illustrative examples. The precise chemical reaction mechanism can frequently be determined only with difficulty. Further possible reaction mechanisms of the oxidation of metals are, for example, described in Hollemann, Wiberg, Lehrbuch der Anorganischen Chemie, 101^{st} edition, de Gruyter Verlag, 1995.

After the oxidation is complete, the metal oxide particles can, in one process variant, be comminuted directly in the liquid in which the oxidation was carried out. If desired, further components or additives can be added before comminution, for example in order to aid comminution or to occupy the surfaces of the metal oxide particles or functionalize them for later use. In a further variant of the invention, the metal oxide particles can be separated off from the liquid in which the oxidation was carried out. The separation can be carried out by directly removing the liquid from the reaction mixture. This can be effected by methods known to those skilled in the art, e.g. thermal drying, preferably in an atmosphere having a reduced pressure. The liquid is preferably separated off after initial concentration of the solid has been carried out by means of a simple process, in particular by filtration.

After the separation, the metal oxide particles can optionally be passed to a heat treatment, i.e. an additional thermal treatment. The heat treatment or this thermal treatment enables, in particular, the chemical composition and/or the crystal structure of the metal oxide particles to be altered. The temperatures of such a thermal treatment are typically above 200° C., but below the melting point or decomposition temperature. The duration is typically from a few minutes to some hours. For example, aluminum hydroxide which has been prepared by reaction of aluminum metal powder in water can be converted into aluminum oxide by heating to temperatures of more than 400° C. with elimination of water. In a further thermal treatment in the range from 800° C. to 1300° C., the crystal structure of the aluminum oxide can be set in a targeted manner. Thus, for example, γ-Al₂O₃ is converted into α-Al₂O₃ on heating to temperatures above 800° C.

It is of course also possible according to the invention to carry out a thermal treatment (heat treatment) of the metallic particles or the metallic powder obtained in step (a) and/or the deformed metallic particles or metallic powder obtained in the optional step (b) in addition to or as an alternative to the thermal treatment (heat treatment) of the metal oxide particles or metal oxide powder obtained in step (c).

Apart from the reaction in a liquid phase or liquid, the oxidation can also be carried out by gas-phase oxidation, for example by direct combustion of the metallic powder or metal powder. In this case, the metallic powder or metal powder is burnt by introduction of energy and of an oxidizing gas. This can be carried out by the metallic powder or metal powder being fed into a reactor in which the metallic powder or metal powder is mixed with an oxidizing gas, e.g. air or oxygen, and oxidized by introduction of energy. The feeding-in of the metallic powder can be carried out mechanically, by means of a powder metering device, manually or preferably by means of a gas stream, for example using a gas such as nitrogen, argon, oxygen, etc., or a gas mixture.

The introduction of energy in the form of heat can, in particular, be effected by means of a burner, e.g. a gas-fuel burner or a pure gas burner, by means of a hot wall reactor, by means of a plasma source or by means of an electric arc. The energy is preferably introduced by means of a burner, particularly preferably by means of a burner which utilizes hydrogen as energy source. The temperature during the oxidation can be in the range from 500° C. to 5000° C., preferably from 1000 to 2500° C. The respective temperature is chosen as a function of the metal to be oxidized and the production throughput.

The parameters are set so that the oxidation of the metal is preferably virtually complete, i.e. the proportion of metal in the oxidation state zero is preferably less than 10% by weight, more preferably less than 5% by weight, even more preferably less than 0.5% by weight and very preferably less than 0.25% by weight, during the residence time in the reactor. After the oxidation, the metal oxide powder can be collected. This collection can be carried out using all methods known to those skilled in the art. Collection is preferably carried out by means of filtration. Before collection, the metal oxide powder can optionally be cooled, which can be achieved, for example, in a gas which is fed in.

After steps (a), optionally (b) and (c) of the process of the invention, a powder of a metal oxide or a suspension of the metal oxide powder in a liquid can be obtained. The metal oxide powder obtained after step (c) has a number of advantages.
It can be produced inexpensively.
Selection of suitable metals as starting materials makes it possible to obtain highly pure (for example >99.5% by weight content of the desired metal oxide) or impure metal oxides (for example >50% by weight content of the desired metal oxide) or metal oxides which have been doped in a targeted manner. It is also possible to produce metal oxide powders comprising metal oxide particles which have a precisely determined composition as a mixture of at least two, three, four or more different metal oxide powders or particles. In addition, it is possible to mix a plurality of metal oxide powders, preferably two, three, four or more metal oxide powders, which have each been obtained via steps (a), optionally (b) and (c) of the process of the invention.
The metal oxide powder obtained after step (c) of the process of the invention preferably has a particle diameter D₅₀ in the range from 1 to 200 μm. Metal oxide powders having such a particle size distribution are particularly suitable for comminution in step (d) of the process of the invention.

In step (d) of the process of the invention, the metal oxide powder is comminuted. In a preferred embodiment of the invention, the comminution of the particles is carried out in a chosen liquid. The comminution is, in a particularly preferred embodiment, carried out by milling in mills. In particular, it is possible to use mills having loose milling media, preferably milling balls, in particular in stirred ball mills. Comminution in such mills is carried out using milling media to comminute the metal oxide particles. Here, energy is imparted by means of a mechanical system to the milling media, preferably milling balls. As a result of impact with the particles, the energy of the milling media, preferably milling balls, is to a particular extent transferred to the metal oxide particles. When the transferred energy is sufficient, the metal oxide particles break up.

A difficulty in the construction of such mills is the separation of the milling media, preferably milling balls, from the milled material. This is normally solved by the milling space of the mill being configured so that only the milled material but not the milling media can leave the milling space. This is usually achieved by using a mechanical separation system in the milling space which allows passage of only the milled material but not the milling media. Such separation systems usually separate according to size. The separation system is thus configured so that it has openings which are smaller than the smallest diameter of the milling media but larger than the greatest diameter of the milled material. In this way, the milling media cannot leave the mill.

To comminute a powder in size ranges below 100 nm, very small balls have to be used. According to a simple rule which is known to those skilled in the art, the diameter of the milling media, preferably milling balls, must be not more than 1000 times the desired particle diameter. According to this rule, particles having a diameter of 50 nm have to be produced using milling media, preferably milling balls, having a diameter of 50 μm. Since this is only an empirically derived rule, upward and downward deviations are possible.

There is accordingly a maximum size of the milling media which can be used in the comminution. This maximum size of the milling media determines the maximum particle size of the powder to be comminuted in two ways. Firstly, the maximum size of the milling media determines a characteristic size of the separation system necessary for separating off the milling media. As separation system, it is possible to use, for example, sieve cartridges. These have a characteristic gap size. Material having a particle size below this gap size can pass through the sieve cartridge while material having a larger particle size cannot pass through the sieve cartridge. The gap size has to be, according to a rule of thumb known to those skilled in the art, at least one third of the size of the milling media. Accordingly, the powder to be comminuted likewise has to have a particle size which is not more than this particle size since otherwise the powder would also be retained in the milling space, which would lead to blockage of the mill.

Secondly, the maximum energy which can be imparted by means of a milling medium is limited. The transferable energy SE (SE: stressing energy) can be calculated by means of the following equation.

SE=(milling medium diameter [m])³*density_milling media [kg/m³]*(circumferential velocity [m/s])²

The circumferential velocity is the velocity of the mechanical component which imparts energy to the milling media, preferably milling balls. At a constant circumferential velocity and a constant density of the milling media, the stressing energy is a function of the size of the milling media. To comminute a metal oxide particle, a certain minimum energy has to be applied in each case. Accordingly, comminution only to a particular maximum metal oxide particle size can be achieved using a particular size of milling media.

For these reasons, the maximum particle size of the metal oxide particles which are to be comminuted to a particular maximum particle size is fixed. Metal oxide particles having a particle size in the range from 1 μm to 200 μm, preferably from 5 to 100 μm, where at least one dimension of the metal oxide particles is in this size range, are particularly suitable for producing the dispersions according to the invention.

It has now surprisingly been found that in the production of dispersions comprising metal oxide nanoparticles by the process of the invention, the metal oxide particles before comminution are present in a particle size which is ideal for the comminution process. It has additionally been found that the production of dispersions comprising metal oxide nanoparticles by the process surprisingly proceeds extremely advantageously in terms of energy and costs.

As a result of the atomization step (a), preferably atomization, metallic powders or metal powders having an average particle size D₅₀ in the range from 1 μm and 100 μm can be produced energetically favorably. The subsequent oxidation step (c) likewise requires little energy since it is an exothermic reaction. In addition, the incorporation of oxygen increases the mass of the particles, so that the energy introduced is negligible when this is based on a particular mass of oxidized metal powder.

In the production of dispersions via gas-phase processes in the prior art, metal oxides are likewise firstly produced. However, since the metal has to be vaporized during the process, substantially more energy is required than in atomization, for example via a nozzle, of a metal melt. Since the metal oxide powder formed here cannot be converted directly into a dispersion, a subsequent dispersing operation with input of energy has to be carried out in these processes. Although metal oxide powders having particles in the size range below 200 μm are likewise present in the processes, these are aggregated and considerable energy has to be additionally introduced for the dispersing operation.

Compared to liquid-phase syntheses from the prior art, the process of the invention has the advantages that the starting materials are significantly cheaper, the achievable concentration is significantly higher and the process of the invention can be scaled up to an industrial scale significantly more simply. Thus, in liquid-phase syntheses, it is usually necessary to use pure metal salts which are then mixed with an appropriate precipitant, resulting in precipitation of nanoparticles. These metal salts are significantly more expensive than the pure metals since they are generally produced by chemical transformation of metals.

Thus, for example, the aluminum chloride required for the precipitation of aluminum hydroxide nanoparticles are obtained by reaction of aluminum with hydrochloric acid. The concentration of nanoparticles, based on the total mass of the reaction product, which can be achieved by precipitation processes is limited since, firstly, the solubility of the starting materials in liquids is limited and, secondly, excessively high precipitation rates would lead to larger particles. Thus, the concentration of aluminum chloride in the precipitation of aluminum hydroxide is typically 1 mol/l or less, corresponding to a solids content of 13% by weight or less. Furthermore, it is very important in the production of nanoparticles by precipitation reactions to define the fluid-dynamic parameters precisely. In particular, the stirring speed or the liquid velocity have to be set in a targeted manner. A virtually uniform spatial distribution of the chemical species in the solution is sought by means of this movement of the liquid, i.e. concentration gradients should be avoided. However, this uniform distribution is virtually impossible to achieve or can be achieved only with an enormous outlay in relatively large reactors. For this reason, microreactors are increasingly used for the synthesis, but these have the disadvantage of a greatly restricted production throughput. Scale-up of precipitation processes to an industrial production scale is therefore difficult.

Such difficulties surprisingly do not occur in the process of the invention. Process steps (a) and (c) for producing the oxidized metal powder are both inexpensive and can readily be scaled up. Both these advantages also apply for step (d) of the subsequent comminution.

In a particularly preferred embodiment of the comminution step (d), the energy used in a stirred ball mill is transferred by means of a mechanical structure to the metal oxide particles to be comminuted. This energy transfer is usually effected by a motor being driven by energy and this motor transfers, by means of a shaft, also referred to as a rotor, energy to components which transfer the energy to the loose milling media, preferably milling balls, by direct or indirect contact. These components can be disks, perforated or slotted disks, pins or other components known to those skilled in the art. The rotor can also have different geometries known to those skilled in the art. This geometry is preferably optimized in such a way that it firstly favors energy transfer and secondly aids separation of the milling media from the milled material. The milling space, also referred to as stator, can likewise have various geometries which can likewise be optimized for the functions described.

Rotor and stator, i.e. the rotor-stator system, can in principle be made of any material. Materials which have sufficient chemical and mechanical resistance in the comminution step are particularly suitable. In particular, metals, ceramics, plastics and cemented carbides are suitable for the manufacture of rotor and stator. The stator is preferably made of or lined with aluminum oxide, silicon carbide or zirconium oxide at least in the regions in which it comes into contact with the metal oxide particles and the milling media. The rotor is preferably likewise made of one of these materials or of polyurethane, polyamide or polyethylene or lined with these materials. It is of course also possible for not the entire rotor and/or stator to be made of the materials mentioned but for only the surfaces which come into contact with the metal oxide particles and the milling media to be at least provided with or coated with one of these materials. Rotor and stator advantageously consist of the same material as the metal oxide particles to be milled since in this case any abrasion which occurs does not contaminate the product, viz. the metal oxide nanoparticles.

During milling, the stator and/or the rotor is, in a particularly preferred process variant, actively cooled in order to remove the heat produced by friction from the rotor-stator system. Cooling can, for example, be effected by use of a stator having a double-walled structure, with cooling water being conveyed through the double wall. The heat taken up by the cooling water can then be removed from this again by means of a circulation cooler (e.g. from Lauda, Germany).

The speed with which the rotor rotates is usually reported as a function of the external diameter of the energy-imparting component, for example a disk. This speed is also referred to as stirrer circumferential velocity or “tip speed”. This speed is in the range from 1 to 25 m/s in process step (d) of the process of the invention. As milling media, preference is given to using balls made of ceramic, metal or a metal oxide. The balls preferably consist of stainless steel, zirconium oxide, glass or aluminum oxide. In a further preferred variant, the balls consist of a doped material, e.g. yttrium-doped zirconium oxide balls. The balls advantageously consist of the same material as the metal oxide particles to be milled, since in this case any abrasion which occurs does not contaminate the metal oxide particles.

The metal oxide particles are particularly preferably circulated through the mill (recycle mode) during comminution. Here, a reservoir in which the metal oxide particles can be stirred can be integrated into the circuit. In a preferred variant, this reservoir is likewise actively cooled in order to improve heat removal.

The milling space capacity of the ball mill used can be in the range from 0.5 liter to 10 000 liters. Such mills are commercially available from various suppliers.

During milling, the primary particle diameter of the metal oxide particles decreases. For this reason, the number of metal oxide particles and the specific surface area, which can be reported in [m²/g], increase. To prevent formation of agglomerates, additives which prevent agglomeration are preferably added. These additives can stabilize the dispersion by means of electrostatic, steric or electrosteric mechanisms. For the purposes of the invention, the term “additive” refers to at least one additive. The additive can thus also be an additive mixture. The addition of the additive or the additive mixture can be carried out in one or more portions before or during milling. If a plurality of additives are added, these can be added simultaneously as a mixture or in portions in various proportions. The amount of additive, based on the weight of the total dispersion, can be from 0.1% by weight to 60% by weight. The amount of additive is preferably from 0.5% by weight to 50% by weight. The amount can also be based on the amount of metal oxide particles. In this case, the amount of additive is preferably from 2% by weight to 500% by weight, preferably from 3% by weight to 400% by weight.

The additives can be substances which form a permanent or temporary bond with the metal oxide particles. In particular, the additive or additives can be bound via chemical or physical bonds to the metal oxide particle surface. Here, chemical bonds can form between the metal oxide particle surface or active groups on the surface of the metal oxide particles. The additive or additives can also be bound by physical bonding such as physisorption or be absorptively bound in pores which may be present in the metal oxide particles. Bonding of the additive or additives can also be via van der Waals or electrostatic forces. The additive or additives preferably consist(s) of a base molecule and active groups. The active groups can be terminally arranged on the additive or be distributed over the entire base molecule. The number of active groups is preferably at least one. However, it is also possible for two, three or more active groups to be present. The active groups can, firstly, serve to achieve good bonding of the additive to the metal oxide surface and, secondly, ensure good compatibility of the additive with the surrounding liquid. Examples of such active groups are acid groups, amine groups, hydroxy groups, sulfur groups, amide groups, imide groups and phosphorus groups.

The base molecule of the additive can either be without a function, ensure good compatibility with the metal oxide particles, ensure good compatibility with the surrounding liquid or have a particular molecular length which is helpful for stabilization. The base molecule can also have a backbone composed of alkyl chains or siloxane chains which preferably have a molecular weight in the range from 200 to 200 000 g/mol, preferably from 501 to 100 000 g/mol. The additive can in principle have any chemical structure. The additive can have a molecular weight in the range from 200 to 200 000 g/mol. The additive preferably has a molecular weight in the range from 501 to 100 000 g/mol and particularly preferably from 700 to 90 000 g/mol. The additive can comprise salts, surfactants, oligomers or polymers in which the backbone preferably has alkyl chains or siloxane chains. Preference is given to polymers or block polymers having groups which have an affinity for solids.

In a preferred embodiment of the invention, the particle diameter D₉₀ of the metal oxide particles or the metal oxide powder in the dispersion produced by the process of the invention is in the range from 1 nm to 300 nm, preferably from 5 nm to 250 nm, more preferably from 10 nm to 200 nm, even more preferably from 20 nm to 150 nm, even more preferably from 30 nm to 100 nm. A particle diameter D₉₀ in the range from 40 nm to 80 nm has been found to be particularly suitable.

After milling, the dispersion is optionally concentrated to the desired solids content. This concentrating operation can be carried out by means of any technique known to those skilled in the art, e.g. by separating off the liquid phase or liquid, for example by vacuum evaporation, crossflow filtration, continuous or batchwise centrifugation, filtration or by increasing the content of metal oxide particles.

The object of the invention is also achieved by a dispersion which can be obtained by the process of the invention.

The dispersion of the invention is, in particular, characterized in that the metal oxide particles in the dispersion are homogeneously distributed and are in essentially unaggregated form. Preference is given to at least 95% by weight, more preferably at least 98% by weight, even more preferably 99% by weight, even more preferably at least 99.5% by weight, of the metal oxide particles being present in unaggregated form. The dispersion of the invention is also preferably characterized in that the degree of aggregation increases by not more than 2% by weight/month of storage time at 20° C., preferably by not more than 1% by weight/month of storage time at 20° C., more preferably by not more than 0.5% by weight/month of storage time at 20° C. In a very preferred variant, the degree of aggregation increases by not more than 0.1% by weight/month of storage time at 20° C.

In a preferred embodiment of the invention, the metal oxide particles are largely stabilized by the steric effect of the additive. In this case, the absolute value of the zeta potential is less than 30 mV and more preferably less than 15 mV.

In a further preferred embodiment of the invention, the metal oxide particles are largely stabilized by the electrostatic and/or electrosteric stabilization mechanism in the dispersion. Here, the absolute value of the zeta potential of the metal oxide particles present in the dispersion at a pH of from 6.5 to 9.5 is in the range from 20 to 150 mV, preferably from 30 mV to 100 mV, with the average particle diameter preferably being in the range from 10 to 300 nm, more preferably from 30 to 100 nm.

The dispersion according to the invention which can be obtained by the process of the invention is particularly suitable for use as auxiliary for scratch-resistant surface coatings, as UV absorber in surface coatings, cosmetics, plastics or printing inks.

Aluminum oxide dispersions, in particular α-Al₂O₃ (α-alumina), can be used as abrasives.

ZnO dispersions can be used as transparent, conductive coatings.

### FIGURES

FIG. 1 shows a schematic flow diagram of the process of the invention for producing a dispersion.

FIG. 2 shows the particle size and zeta potential of a deformed and oxidized aluminum powder as a function of the pH, measured using ultrasound spectroscopy.

FIG. 3 shows an XRD spectrum of a deformed and oxidized aluminum powder.

FIG. 4 shows the particle size and the zeta potential of a deformed, oxidized and subsequently heat-treated aluminum powder as a function of the pH measured using ultrasound spectroscopy.

FIG. 5 shows an XRD spectrum of a deformed, oxidized and subsequently heat-treated aluminum powder.

FIG. 6 shows the changes in the particle size and the zeta potential during milling of a deformed and oxidized aluminum powder at pH=5.

FIG. 7 shows a scanning electron micrograph after milling of a deformed and oxidized aluminum powder at pH=5.

FIG. 8 shows the XRD spectrum of the zinc oxide powder obtained after oxidation in example 2 according to the invention.

FIG. 9 shows the UV/Vis spectrum of the dispersion obtained after comminution with additive in example 2 according to the invention.

The following examples merely illustrate the invention without restricting it.

### EXAMPLE 1 ACCORDING TO THE INVENTION (ALUMINUM OXIDE)

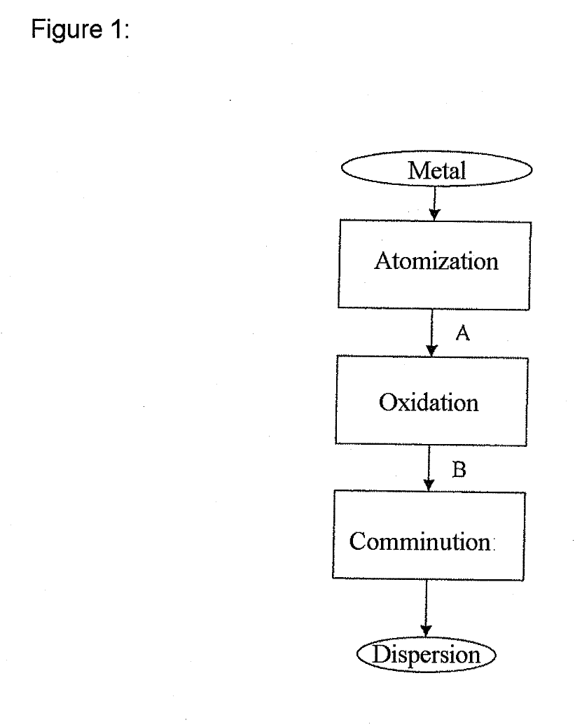

Production of a dispersion of oxidized aluminum powder in water. The course of the process is shown schematically in FIG. 1.

### a) Atomization:

In an induction crucible furnace (from Induga, Cologne, Germany), about 2.5 metric tons of aluminum ingots (metal) are introduced and melted continuously. The aluminum melt is present in liquid form at a temperature of about 720° C. in the receiver. A plurality of nozzles which operate according to an injector principle dip into the melt and atomize the aluminum melt vertically upwards. The atomization gas is compressed to 20 bar in compressors (from Kaeser, Coburg, Germany) and heated to about 700° C. in gas heaters. The aluminum powder formed after atomization/spraying solidifies and cools in flight. The induction furnace is integrated into a closed plant. Spraying is carried out under inert gas (nitrogen). Precipitation of the aluminum powder (A) is carried out firstly in a cyclone, with the pulverulent aluminum precipitated there having a D₅₀ of 14-17 μm. To precipitate further aluminum, a multicyclone is subsequently used, with the pulverulent aluminum deposited in this having a D₅₀ of 2.3-2.8 μm. The gas/solid separation is carried out in a filter (from Alpine, Thailand) equipped with metal elements (from Pall). Here, an aluminum powder having a d10 of 0.7 μm, a d50 of 1.9 μm and a d90 of 3.8 μm is obtained as finest fraction.

### b) Milling:

4 kg of glass balls (diameter: 2 mm), 75 g of very fine aluminum powder (A) from a), 200 g of petroleum spirit and 3.75 g of oleic acid are placed in a pot mill (length: 32 cm, width: 19 cm). Milling is subsequently carried out at 58 rpm for 15 hours. The product is separated from the milling balls by rinsing with petroleum spirit and subsequently sieved by wet sieving on a 25 μm sieve. The fine powder is largely freed of petroleum spirit on a suction filter (about 80% solids content).

### c) Oxidation:

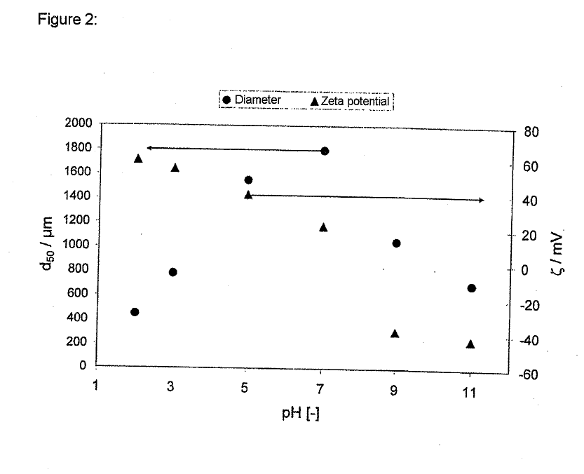

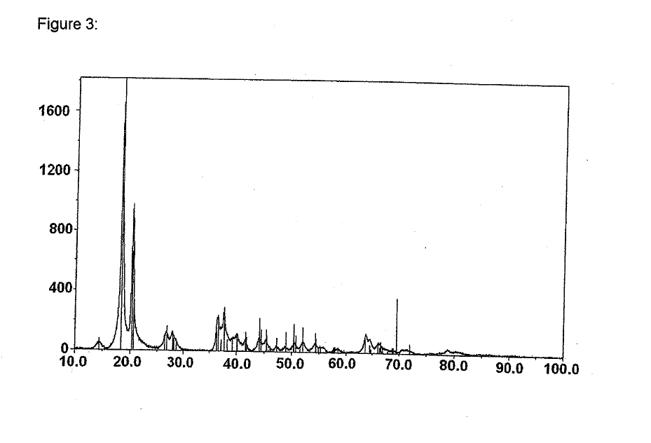

In a 5 l glass reactor, 300 g of an aluminum powder which has been deformed as described under b) are dispersed in 1000 ml of isopropanol (VWR, Germany) by stirring with a propeller stirrer. The suspension is heated to 78° C. 5 g of a 25% strength by weight ammonia solution (VWR, Germany) are subsequently added. After a short time, vigorous gas evolution can be observed. Three hours after the first addition of ammonia, a further 5 g of 25% strength by weight ammonia solution are added. After a further 3 hours, 5 g of 25% strength by weight ammonia solution are again added. The suspension is stirred further overnight. On the next morning, the solid is separated off by means of a suction filter and dried at 50° C. for 48 hours in a vacuum drying oven. A white powder (B) is obtained. This powder was subsequently characterized. Firstly, the particle size and the zeta potential were examined as a function of the pH. The pH was set by means of 1.0M NaOH or 1.0M HCl. The results are shown in FIG. 2. At both a high and a low pH, the zeta potential displays a maximum and the particle diameter displays a minimum. An XRD analysis of the material is shown in FIG. 3. This indicates a composition of about 33% by weight of boehmite (AlOOH) and 67% by weight of gibbsite (Al(OH)₃).

### d) Thermal Treatment:

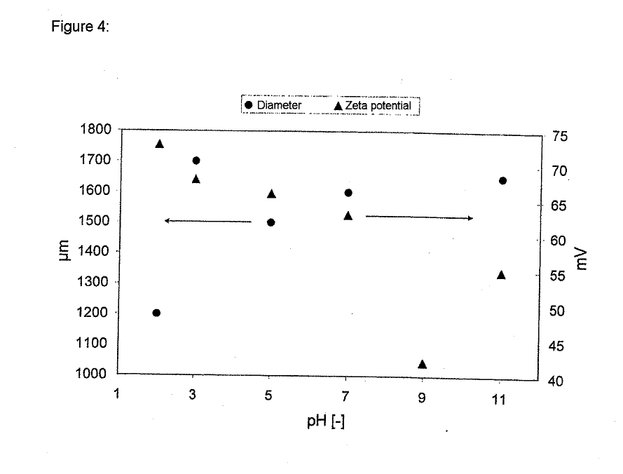

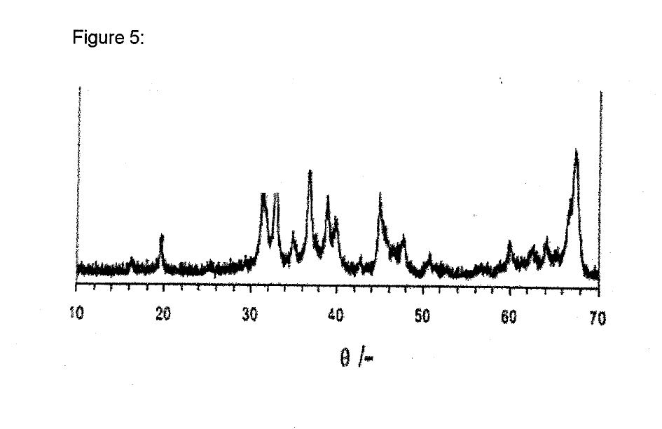

500 g of a material produced as described under c) were heated at 1100° C. for 10 minutes in a rotary tube furnace (Nabertherm, Germany). 335 g of a white powder were obtained. This was examined as described. The results are shown in FIG. 4 and FIG. 5. Compared to the uncalcined material, the particle diameter is somewhat greater and the zeta potential is positive in the entire pH range. The XRD analysis shows theta-Al₂O₃.

e) Comminution, pH-Stabilized:

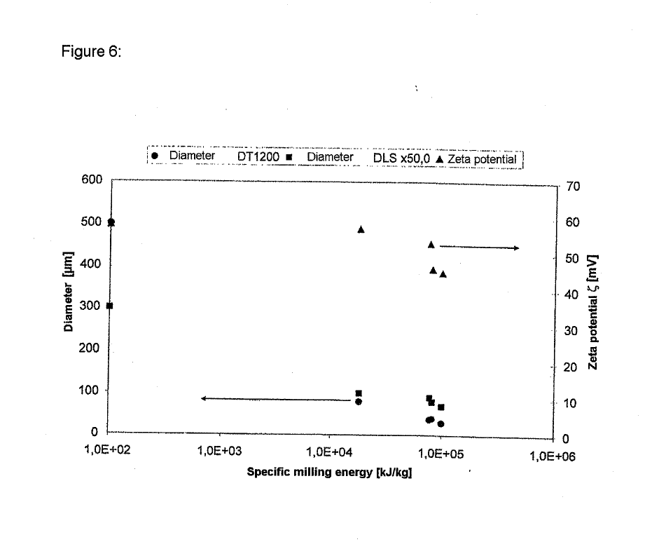

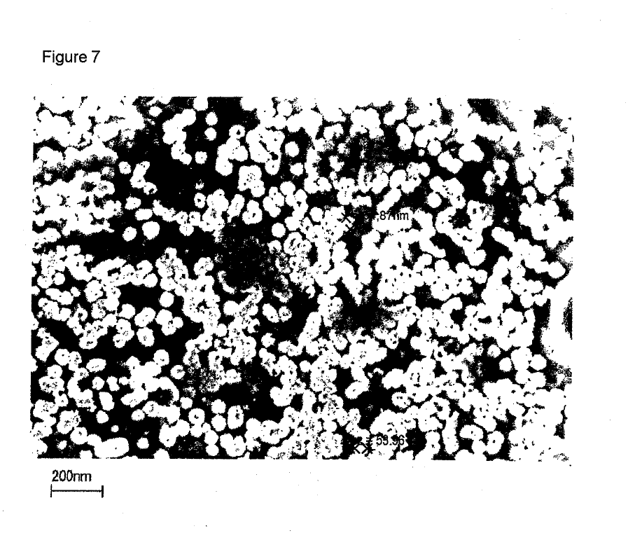

200 g of the material produced as described under c) and 800 g of distilled water were mixed by magnetic stirring. This suspension was milled in a stirred ball mill (Dynomill Pilot A, Willy A. Bachofen, Switzerland) using stabilized zirconium oxide balls (diameter: 0.6 to 0.8 mm). During milling, the pH was kept constant at pH=5 by addition of nitric acid. The progress of milling was monitored by means of ultrasound spectroscopy (DT1200, Quantachrome, Germany) and dynamic light scattering (DLS) (ZetaSizer Nano, Malvern, Germany). The results are shown in FIG. 6. A dispersion (dispersion) having particles smaller than 100 nm was produced (DT1200: 30 nm, ZetaSizer 70 nm). This particle size could be confirmed by scanning electron micrographs (FIG. 7). The dispersion was stable over a number of months without addition of additives.

### EXAMPLE 2 ACCORDING TO THE INVENTION (ZINC OXIDE)

The course of the process is shown in FIG. 1.

### f) Atomization:

In an induction crucible furnace (from Induga, furnace capacity about 2.5 metric tons), zinc ingots (metal) were introduced and melted continuously. The zinc melt was present in liquid form at a temperature of about 790° C. in the receiver. The liquid zinc left the furnace via a nozzle and impinged on a rotating copper disk which was cooled. The impinging stream of zinc cooled and formed zinc powder. The induction furnace was integrated into a closed plant. Atomization was carried out under inert gas (nitrogen). Precipitation of the zinc powder (A) was carried out firstly in a cyclone, with the pulverulent zinc precipitated there having a d₅₀ of 25-38 μm. To precipitate further zinc, a multicyclone was subsequently used, with the pulverulent aluminum deposited in this having a d₅₀ of 17-22 μm. The gas/solid separation was carried out in a filter (from Alpine) equipped with metal elements (from Pall).

### g) Milling:

4 kg of steel balls (diameter: 8 mm), 75 g of (A) from a), 100 g of petroleum spirit and 5 g of oleic acid were placed in a pot mill (length: 32 cm, width: 19 cm). Milling was subsequently carried out at 58 rpm for 12 hours. The product was separated from the milling balls by rinsing with petroleum spirit and subsequently sieved by wet sieving on a 25 μm sieve. The fine powder was largely freed of petroleum spirit on a suction filter (about 80% solids content).

### h) Oxidation:

In a 5 l glass reactor, 300 g of a zinc powder which has been deformed as described under b) are dispersed in 1000 ml of isopropanol (VWR, Germany) by stirring with a propeller stirrer. The suspension is heated to 78° C. 5 g of a 25% strength by weight ammonia solution (VWR, Germany) are subsequently added. After a short time, gas evolution can be observed. Three hours after the first addition of ammonia, a further 5 g of 25% strength by weight ammonia solution are added. After a further 3 hours, 5 g of 25% strength by weight ammonia solution are again added. The suspension is stirred further overnight. On the next morning, the solid is separated off by means of a suction filter and dried at 50° C. for 48 hours in a vacuum drying oven.

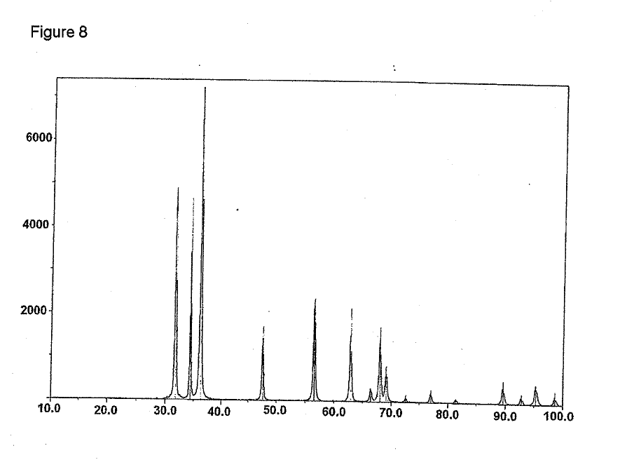

A grayish white powder (B) was obtained. This powder was subsequently characterized by means of XRD analysis. It can be seen from FIG. 8 that the zinc powder was converted into zinc oxide during the reaction. The reflections known for zinc oxide from the literature were clearly visible. In particular, the reflection at 48°, the reflections at 65-70° C. and the reflections above 75° confirmed that it was zinc oxide and not zinc hydroxide which was present, since the latter did not have these reflections.

i) Comminution with Additive:

200 g of the material (B) produced as described under c), 800 g of isopropanol (VWR, Germany) and 60 g of Dapral GE202 (Italmatch Chemicals, Italy) were mixed by magnetic stirring. This suspension was milled in a stirred ball mill (Dynomill Pilot A, Willy A. Bachofen, Switzerland) using stabilized zirconium oxide balls (0.6 to 0.8 mm) for 24 hours.

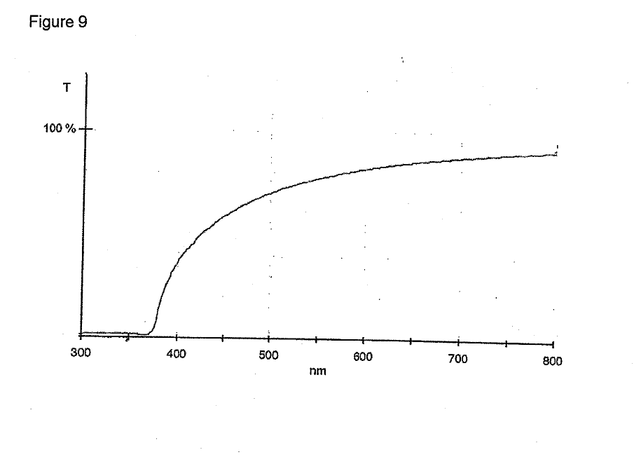

A sample of the dispersion obtained was examined by means of electron microscopy (SEM). The examination was carried out on a Leo Supra 35 instrument from Zeiss. It can be seen that the particle size of the zinc oxide nanoparticles was less than 100 nm. The dispersion was stable on storage over a number of months. A sample of the dispersion was examined in a UV/Vis spectrometer (Lambda 25, Perkin Elmer). The solids content of the sample was 0.01%. The spectrum shown in FIG. 9 clearly shows the good transparency in the region of visible light (400 nm to 800 nm) and also the good absorption of UV light below 400 nm.

1. A process for producing a dispersion containing metal oxide nanoparticles in a liquid phase, wherein the process comprises the following steps:
(a) atomizing a metal melt to produce a metallic powder,
(b) optionally deforming the metallic powder obtained in step (a),
(c) oxidizing the metallic powder obtained in step (a) or (b) to produce a metal oxide powder, and
(d) comminuting the metal oxide powder obtained in step (c) in the presence of a liquid phase to produce a dispersion whose metal oxide particles have a particle size d_{90,oxide} of less than 300 nm.

2. The process as claimed in claim 1, wherein the metallic powder obtained in step (a) is classified on the basis of particle size.

3. The process as claimed in claim 1, wherein the metallic powder obtained in step (a) or (b) has a particle size having a d_{99,metai} of not more than 50 μm.

4. The process as claimed in claim 1, wherein, in step (c) the metallic particles are oxidized by at least one of gas-phase oxidation and liquid-phase oxidation.

5. The process as claimed in claim 1, wherein the metal oxide powder obtained in step (c) is dispersed in a liquid phase before comminution step (d).

6. The process as claimed in claim 1, wherein the particles present after at least one of steps (a), (b) and (c) are heat treated.

7. The process as claimed in claim 1, wherein the mechanical deformation in step (b) is carried out by milling.

8. The process as claimed in claim 1, wherein the metal melt in step (a) contains metal selected from the group consisting of aluminum, iron, copper, magnesium, zinc, tin, zirconium, hafnium, titanium and alloys and mixtures thereof.

9. The process as claimed in claim 8, wherein the metal melt in step (a) contains metal selected from the group consisting of aluminum, zinc, tin, titanium, iron, copper and alloys and mixtures thereof.

10. A dispersion obtained by the process as claimed in claim 1.

11. The process as claimed in claim 7, wherein the milling step is carried out in a mill.
